(19) United States
(12) Patent Application Publication
(10) Pub. No.: US 2009/0231879 A1
(43) Pub. Date: Sep. 17, 2009

(54) CONNECTOR

(75) Inventors: Yi Bin LEE, Taoyuan Hsien (TW); Chih Tse CHEN, Taoyuan Hsien (TW); Chen Jung CHEN, Taoyuan Hsien (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: DELTA ELECTRONICS, INC.

(21) Appl. No.: 12/186,259

(22) Filed: Aug. 5, 2008

(30) Foreign Application Priority Data
Mar. 7, 2008 (TW) 097108187

(51) Int. Cl. F21V 17/00; F21V 15/01; F21V 3/00

(52) U.S. Cl. 362/581; 362/362

(57) ABSTRACT

The invention discloses a connector including a housing, a light-emitting device, and a light-guiding member. The light-emitting device includes a light-emitting portion and at least one wire. The light-guiding member is assembled with the housing and includes at least one light-guiding part and at least one clamping part. The clamping part is used for clamping the light-emitting portion so that the light-emitting housing faces the light-guiding part.

### CROSS REFERENCE TO RELATED APPLICATIONS

This non-provisional application claims priority under 35 U.S.C. §119(a) on Patent Application No(s). 097108187 filed in Taiwan, Republic of China on Mar. 7, 2008, the entire contents of which are hereby incorporated by reference.

### BACKGROUND OF THE INVENTION

1. Field of the Invention

The invention relates to a connector, and particularly relates to a connector having a light-guiding member.

2. Description of the Prior Art

In order for users to know the real-time working status of a connector, a indicating lamp is generally installed in a connector. For example, if a network line is inserted into a RJ-45 connector, the lighting of the indicating lamp refers to a correct connection between the inserted network line and the connector, and the twinkling of the situation lamp refers to a signal transmission between the network line and the connector.

Generally, the whole structure of a general RJ-45 connector is covered by a single piece of metal cover. Thus, after completing the assembly of the RJ-45 connector, the indicating lamp can not be removed or replaced without damaging the RJ-45 connector. In other words, when the indicating lamp is damaged, the present solution is to replace the whole RJ-45 connector. As a result, the manufacture cost of RJ-45 connector can not be reduced, and the yield rate of RJ-45 connector can not be raised.

### SUMMARY OF THE INVENTION

The invention provides a connector capable of arbitrarily matching and replacing a light-emitting device, and further reduces the manufacture cost and raises the yield rate.

In order to achieve the aforesaid scope, the connector of the invention includes a housing, a light-emitting device, and a light-guiding member. The housing includes a connection terminal, and the light-emitting device includes a light-emitting portion and at least one wire. The light-guiding member is assembled with in the housing and includes at least one light-guiding part and at least one clamping part. The clamping part is used for clamping the light-emitting portion so that the light-emitting portion faces the light-guiding part.

Additionally, the connector further includes at least one cover for covering at least one part of the housing, at least one part of the clamping part, or the wire.

According to the present invention, the light-emitting portion can be fixed by being clamped so that the connector can match different light-emitting devices. The light-emitting devices can be easily removed and replaced to raise the product variety and lower the manufacture cost. In addition, the connector of the invention has a cover for shielding EMI so that the EMI generated between environment and the connector can be reduced, and the working efficiency of the connector can be raised.

### BRIEF DESCRIPTION OF THE APPENDED DRAWINGS

The present invention will become more fully understood from the detailed description given herein below and the accompanying drawings which are given by way of illustration only, and thus are not limitative of the present invention, and wherein:

FIG. 1 is a schematic diagram illustrating a connector according to an embodiment of the present invention;

FIG. 2A is a schematic diagram illustrating the light-guiding member and the light-emitting device shown in FIG. 1; and

FIG. 2B is a schematic diagram illustrating another light-guiding member and the light-emitting device according to another embodiment of the present invention.

### DETAILED DESCRIPTION OF THE INVENTION

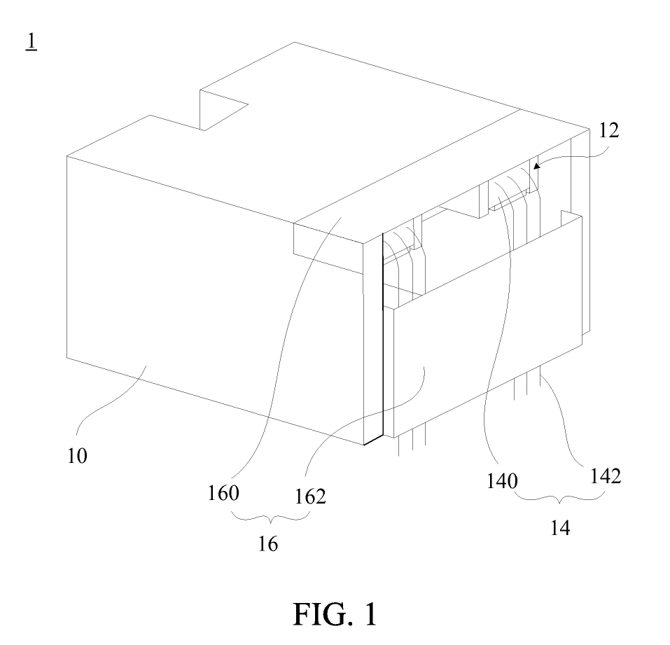

The present invention provides a connector having a light-emitting device which can be removed and replaced easily. As shown in FIG. 1, a connector 1 includes a housing 10, a light-guiding member 12, and a light-emitting device 14. The connector 1 is a RJ-45 or RJ-11 connector and can be applied to the network equipment.

In this embodiment, the light-emitting device 14 includes a light-emitting portion 140 and a wire 142. The light-emitting portion 140 can be a light emitting diode or a laser diode. The light-emitting device 14 can be taken as an indicating lamp, and the working status of the connector 1 can be known according to the twinkling and brightness of the light-emitting device 14. In addition, the light-emitting portion 140 is not limited to emit a monochromatic light, and it can be packaged by several light-emitting sources to emit a light with multiple colors. Meanwhile, the number of wires needs to be configured corresponding to the number of light-emitting sources.

Further, the wire 142 can extend straight or extend along a sidewall of the housing 10. Moreover, a fixing member (not shown) is formed on the housing 10 or the cover 16 for positioning or fixing the wire 142. Therein, the material of the fixing member can be an insulating material or a metal material. The light-guiding member 12 is assembled with the housing 10.

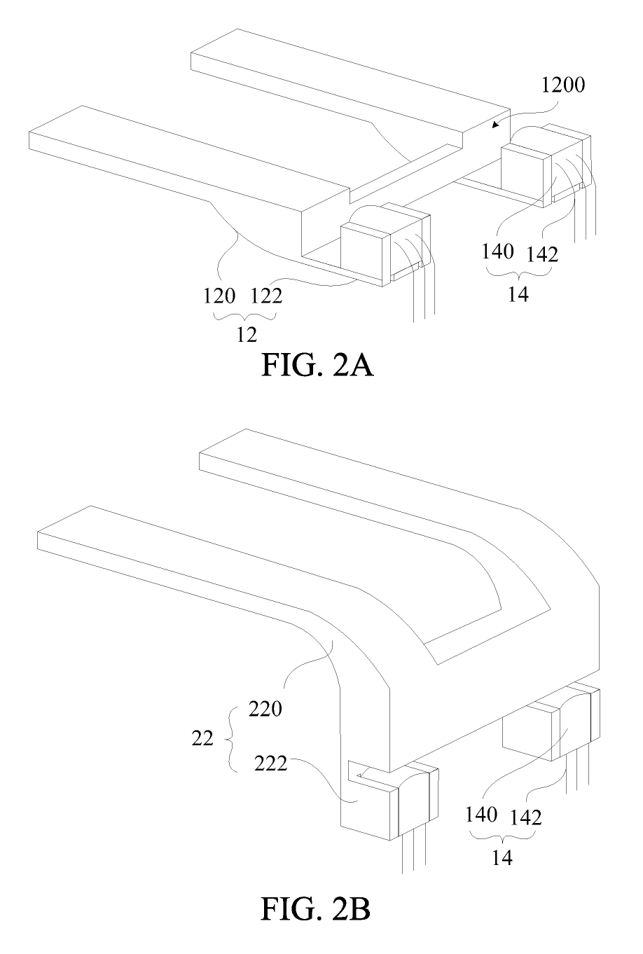

Please refer to FIG. 2A, the light-guiding member 12 includes a light-guiding part 120 and a clamping part 122. The clamping part 122 is used for clamping the light-emitting portion 140 so that the light-emitting portion 140 faces the light-guiding part 120. The light-guiding member 12 is separably connected to the light-emitting device 14, i.e., the light-guiding member 12 is conjoined with the light-emitting device 14 by a clamping force. The light-emitting device 14 of the connector 1 of the present invention can be easily removed and replaced.

Again referring to FIG. 1, the connector 1 further includes a cover 16. The material of the cover 16 can be an electrically conductive material such as metal. The cover 16 includes a first cover part 160 and a second cover part 162, and both of which are separable. The first cover part 160 is used for covering a side of the housing 10 and a side of the clamping part 122, and the second cover part 162 is used for covering the wire 142. Accordingly, the cover 16 not only protects the light-guiding member 12 and the light-emitting device 14, but also shields the EMI generated from the wire 142 and the light-emitting portion 140 surrounded by the clamping part 122.

Again referring to FIG. 2A, the clamping part 122 of the light-guiding member 12 can be used for clamping the light-emitting portion 140, and a first surface 1200 of the light-guiding part 120 can receive the light emitted from the light-emitting portion 140. Therein, the first surface 1200 is not limited to a flat surface, and can be a curve surface, a sawtooth surface, or a wavy surface for matching a surface of the light-emitting portion 140 to gather more light emitted from the light-emitting portion 140.

Additionally, the light-guiding member 12 can have a different structure depending on a practical design or a demand of the manufacture. The clamping part 122 has a U-shape, V-shape, C-shape, N-shape, Z-shape, S-shape, X-shape, Y-shape, J-shape, H-shape, or W-shape profile. The light-guiding part 120 is a curved, linear, L-shape (shown as the light-guiding part 220 in FIG. 2B), sawtooth, wavy, W-shape, or U-shape solid body or hollow body. Besides, the light-guiding part 120 is not limited to a solid body shown in FIG. 2A and FIG. 2B, and can be a hollow body to meet the needs of different optical designs or manufacture.

The housing 10 is connected to the light-guiding member 12 by fitting, embedding, inserting or clamping. Besides, the guiding part 120 and the clamping part 122 can be formed as a monolithic piece, and the housing 10 and the light-guiding member 12 can be formed as a monolithic piece. Meanwhile, the light-guiding part of the housing 10 can be a through hole, and the through hole has an interior wall with a reflective layer. The light-guiding part of the housing 10 can also be a transparent housing.

Since the connector of the invention fixes the light-emitting device by a clamping method, the connector can match different light-emitting devices. The light-emitting devices can be easily removed and replaced to raise the product variety and lower the manufacture cost. In addition, the connector of the invention has a cover for shielding EMI, so the EMI between environment and the connector can be reduced, and the working efficiency of the connector is raised.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A connector comprising:
a housing;
a light-emitting device having a light-emitting portion and at least one wire; and
a light-guiding member assembled with the housing and having at least one light-guiding part and at least one clamping part, wherein the clamping part clamps the light-emitting portion so that the light-emitting portion faces the light-guiding part.

2. The connector of claim 1, wherein the clamping part has a U-shape, V-shape, C-shape, N-shape, Z-shape, S-shape, X-shape, Y-shape, J-shape, H-shape, or W-shape profile.

3. The connector of claim 1, wherein the wire extends straight or extends along a sidewall of the housing.

4. The connector of claim 1, further comprising at least one cover for covering a side of the housing, at least one side of the clamping part, or the wire.

5. The connector of claim 4, wherein the cover comprises an electrically conductive material.

6. The connector of claim 4, wherein the cover comprises a first cover part for covering the side of the housing, and a second cover part for covering the wire.

7. The connector of claim 4, wherein the cover comprises a fixing member for positioning or fixing the wire.

8. The connector of claim 7, wherein the fixing member comprises an insulating material or metal.

9. The connector of claim 1, wherein the light-emitting portion is a light-emitting diode or a laser diode.

10. The connector of claim 1, wherein the light-emitting portion emits a monochromatic light or a light with multiple colors.

11. The connector of claim 1, wherein the housing comprises a fixing member for positioning or fixing the wire.

12. The connector of claim 11, wherein the fixing member comprises an insulating material or metal.

13. The connector of claim 1, wherein the light-guiding part is a curved, linear, L-shape, sawtooth, wavy, W-shape, or U-shape solid body or hollow body.

14. The connector of claim 1, wherein the light-guiding part has a curve, sawtooth, or wavy surface.

15. The connector of claim 1, wherein the housing is made of a transparent material.

16. A connector comprising:
a light-emitting device having a light-emitting portion and at least one wire; and
a housing having at least one clamping part for clamping the light-emitting portion.

17. The connector of claim 16, wherein the housing comprises at least one light-guiding part, and the light-emitting portion and the light-guiding member correspond to each other.

18. The connector of claim 17, wherein the light-guiding part is a curved, linear, L-shape, sawtooth, wavy, W-shape, or U-shape solid body or hollow body.

19. The connector of claim 17, wherein the light-guiding part has a curve, sawtooth, or wavy surface.

20. The connector of claim 16, further comprising at least one cover for covering a side of the housing, a side of the clamping part, or the wire.

21. The connector of claim 20, wherein the cover comprises a fixing member for positioning or fixing the wire, and the housing comprises a fixing member for positioning or fixing the wire
